(19) United States
(12) Patent Application Publication
(10) Pub. No.: US 2006/0186239 A1
(43) Pub. Date: Aug. 24, 2006

(54) Hydraulic loading and leveling system for heavy equipment

(76) Inventor: Steve Charles Koontz, Livingston, MT (US)

Correspondence Address: STEVE KOONTZ, 1007 EAGLE CT., LIVINGSTON, MT, 59047, US

(21) Appl. No.: 11/063,697

(22) Filed: Feb. 22, 2005

(51) Int. Cl. B02C 19/00

(52) U.S. Cl. 241/285.1

(57) ABSTRACT

This invention is new to the art of transporting heavy machinery, like rock crushers. Up to this point, these machines have been built with their own integral axles. Axles have a multitude of problems such as licensing, tire maintenance, brake maintenance, light maintenance, to name a few. This invention eliminates all those problems plus has the additional benefit of leveling the machine after it is placed on the job site.

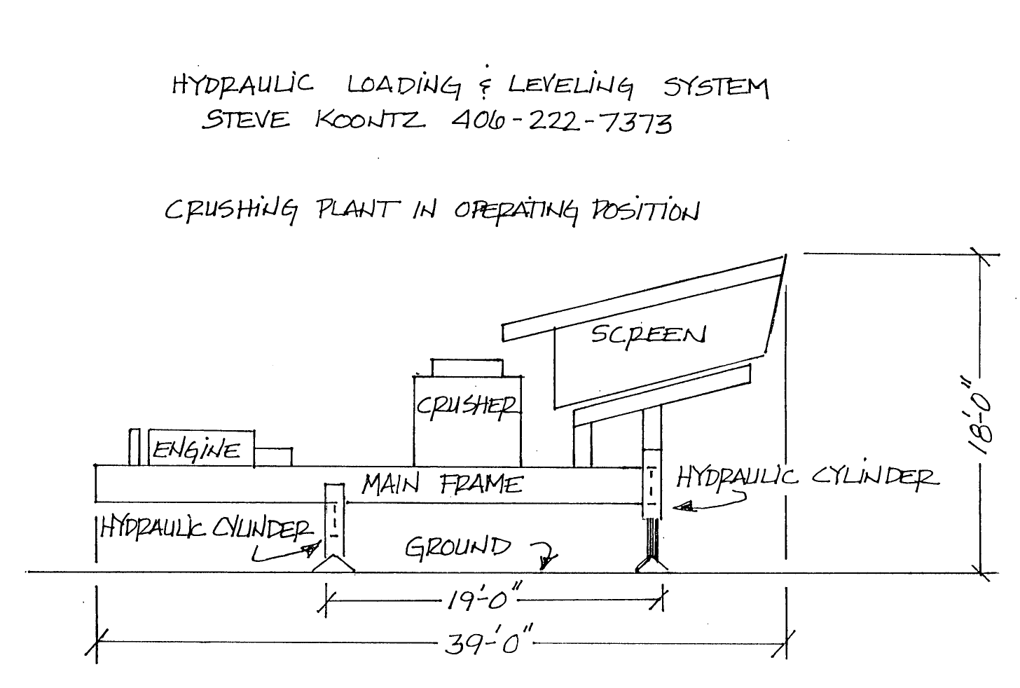

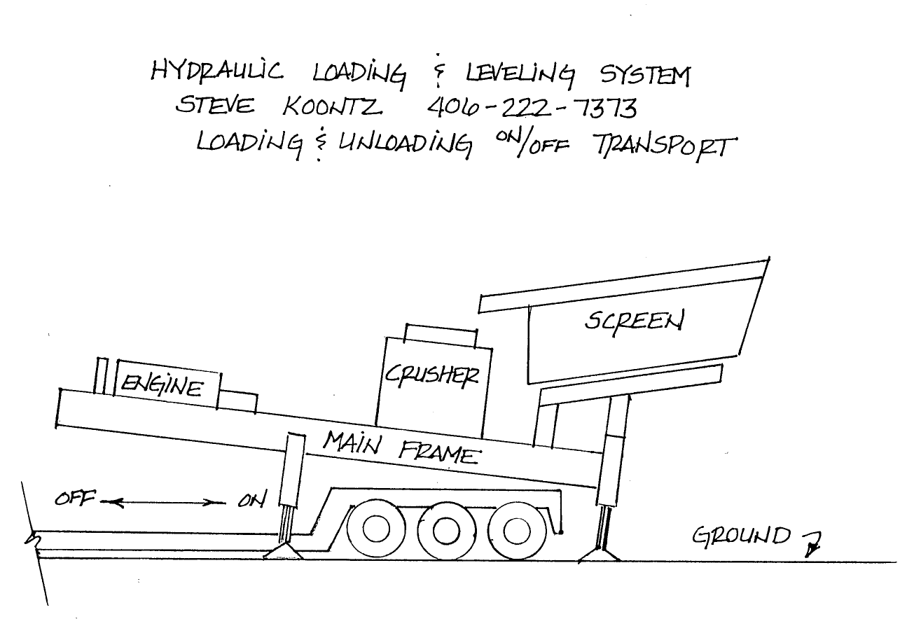

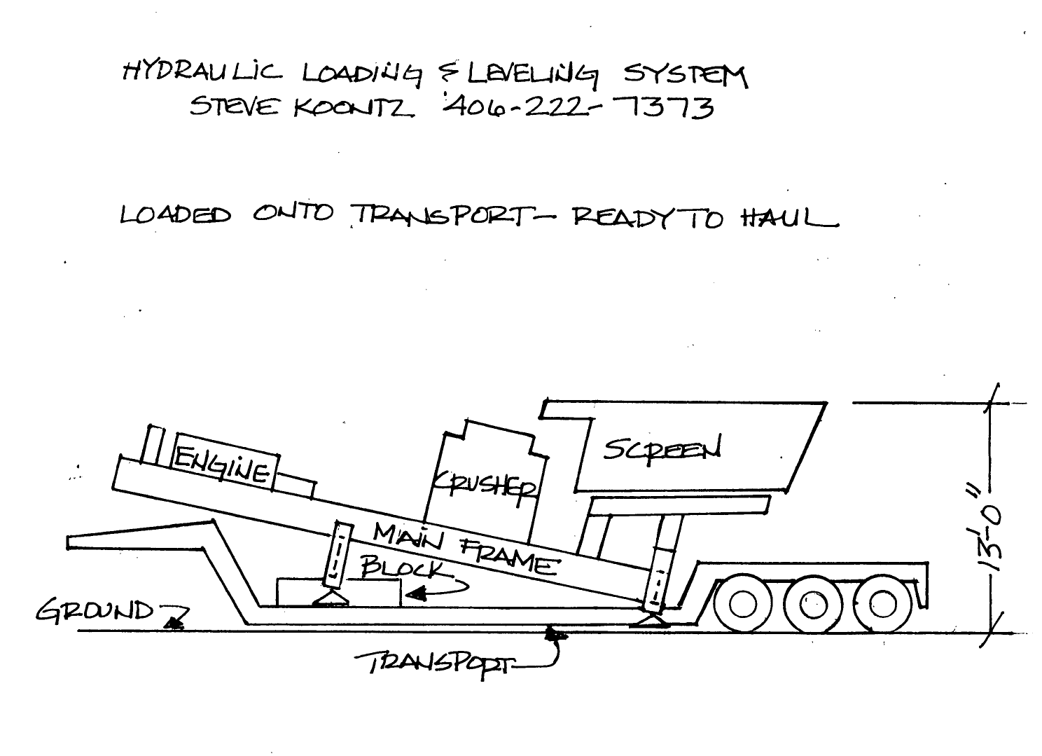

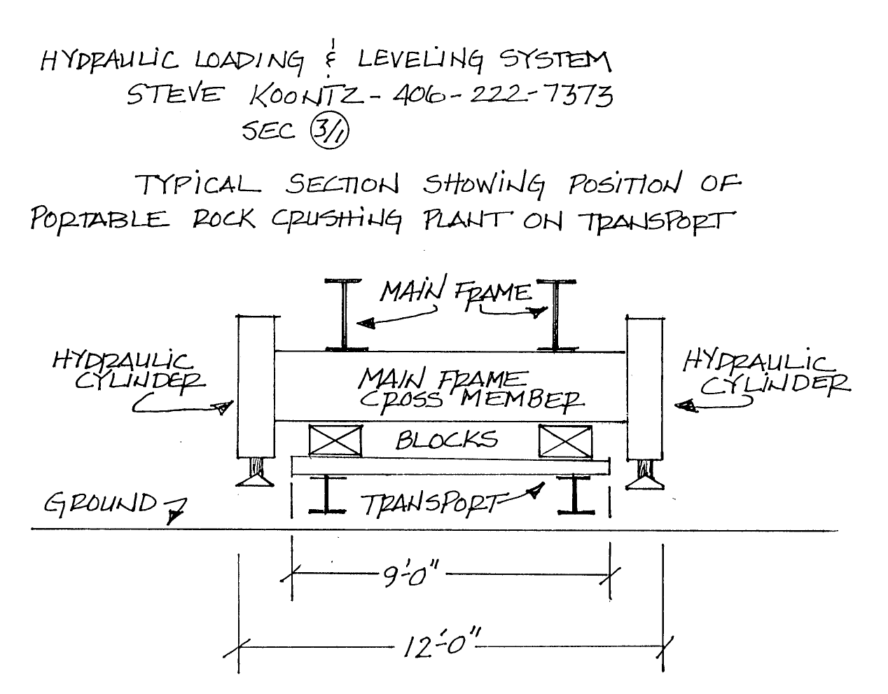

### BACKGROUND

Portable rock crushers are usually installed on axles and are moved from job to job by using a semi tractor. This system has some disadvantages, such as:
Maintenance—Due to the hostile environment of rock crushing, the axles, lights and brakes are constantly being abused. Then, at jobs end, these parts are always in need of repair before the plant can be moved.
Leveling and Cribbing—When the plant is moved to the new site it must be leveled and cribbed or blocked so that all weight is removed from the wheels. This is important because the crushing plant must be resting on a solid base so that it can operate properly. This is not possible if it is left on its wheels.
Licensing—A crusher that has wheels has to be licensed to be legal to move on the highway, between jobs.

### SUMMARY AND DESCRIPTION OF THE INVENTION

This invention consists of a special built frame with four (4) hydraulic cylinders. The frame is constructed in such a way as to provide a place to attach a crusher, engine and an optional screen. The Hydraulic cylinders are spaced so that when fully extended one can back a low boy transport under the plant. When retracted, the entire plant is on the trailer and ready to move to the next site.

### DESCRIPTION OF DRAWINGS

P.1. This drawing shows the crushing plant on site in the operating position.

P.2. This drawing shows the crushing plant with hydraulic jacks extended. Now the trailer can be backed under the plant or removed.

P.3. This drawing shows the crushing plant loaded on the transport ready to move to the next site.

P.4. This drawing shows proper positioning of the crushing plant on the transport trailer.

1. What I claim as my invention is a horizontal frame comprising:
a. mounts and attach points positioned in such a way as to allow mounting of machinery
b. hydraulic cylinders positioned at or near each corner of the frame mounted in a vertical position so as to be able to raise and lower the horizontal frame.
